(19) United States
(12) Patent Application Publication
(10) Pub. No.: US 2026/0127395 A1
(43) Pub. Date: May 7, 2026

(54) Wireless Tag Direction Identification

(71) Applicant: Zebra Technologies Corporation, Lincolnshire, IL (US)

(72) Inventor: Bradley Abelman, Woodbury, NY (US)

(73) Assignee: Zebra Technologies Corporation, Lincolnshire, IL (US)

(21) Appl. No.: 19/307,870

(22) Filed: Aug. 22, 2025

Related U.S. Application Data
(60) Provisional application No. 63/717,245, filed on Nov. 6, 2024.

(51) Int. Cl. G06K 7/10; G06N 3/084; H04B 17/318

(52) U.S. Cl. CPC G06K 7/10099; G06N 3/084; H04B 17/318

(57) ABSTRACT

A method of locating a wireless tag via a computing device is described. At least one rotation sensor is used to determine a plurality of angle data of the computing device in the horizontal plane during motion of the computing device. A plurality of signal strength data of the wireless tag is processed during the motion of the computing device. A plurality of data points are created by correlating ones of the plurality of angle data with ones of the plurality of signal strength data. A non-linear regression machine learning model is trained with the plurality of data points. A visual indicator of a direction of the wireless tag is generated based on the training. A computer readable medium storing the instructions is also described.

This application claims priority from U.S. Provisional Patent Application No. 63/717,245, titled “RFID DIRECTION IDENTIFICATION” and filed on Nov. 6, 2024, the contents of which is incorporated herein by reference.

### BACKGROUND

Major retailers have started tagging their inventory with wireless tags such as radiofrequency identification (RFID) tags. The use of RFID tags provides advantages including improved inventory counting and item location. However, locating an item tagged with an RFID tag in a large facility presents technical and practical challenges because RFID does not provide inherent positional data. Rather, it only indicates the presence of a tag within the detection range of a reader. As a result, “pickers” are required to traverse the space to attempt to locate the items. However, due to the size of the facility and the lack of directional information, it can take the pickers a long time to find the items.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1A is a diagram of computing device used to locate an RFID tag.

FIG. 1B is a diagram of the components of the computing device of FIG. 1A.

FIG. 2 is a flow chart illustrating the operation of the computing device to locate the RFID tag.

FIG. 3 is a graph illustrating a curve representing a plurality of collected data points that is used to determine the direction of the RFID tag.

FIGS. 4A, 4B, 4C, and 4D are polar plots illustrating example curves for different distributions of data points.

FIG. 5 is an example of a display on the screen of the device for directing a user to the location of the RFID tag.

FIGS. 6A, 6B, and 6C are graphs illustrating example results of training an RSSI estimation function.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method of locating a wireless tag via a computing device. The method comprises: using at least one rotation sensor to determine a plurality of angle data of the computing device in the horizontal plane during motion of the computing device; processing a plurality of signal strength data of the wireless tag during the motion of the computing device; creating a plurality of data points by correlating ones of the plurality of angle data with ones of the plurality of signal strength data; training a non-linear regression machine learning model with the plurality of data points; and generating, at the computing device, a visual indicator of a direction of the wireless tag based on the training. The visual indicator of the direction of the wireless tag is displayed at the computing device.

Additional examples disclosed herein are directed to a non-transitory computer readable medium having stored thereon instructions for locating a wireless tag. The instructions, when executed by a processor of a computing device, cause the processor to: use at least one rotation sensor to determine a plurality of angle data of the computing device in the horizontal plane during motion of the computing device; process a plurality of signal strength data of the wireless tag received at one or more antennas during the motion of the computing device; create a plurality of data points by correlating ones of the plurality of angle data with ones of the plurality of signal strength data; train a non-linear regression machine learning model with the plurality of data points; and generate, on a display of the computing device, a visual indicator of a direction of the wireless tag based on the training.

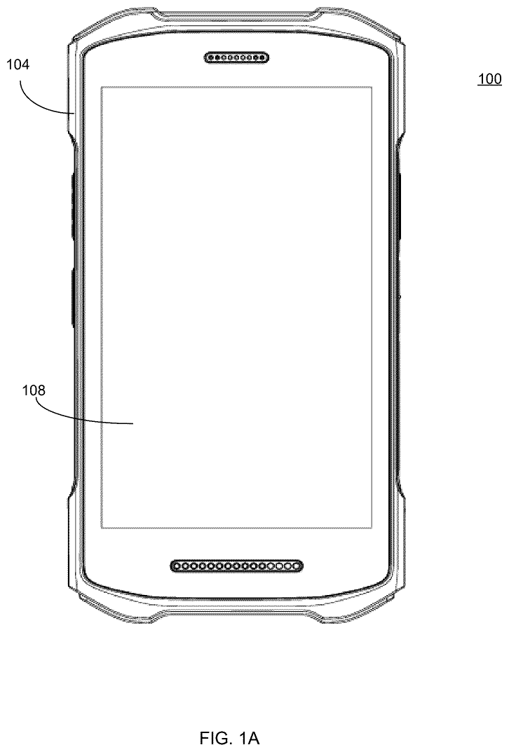

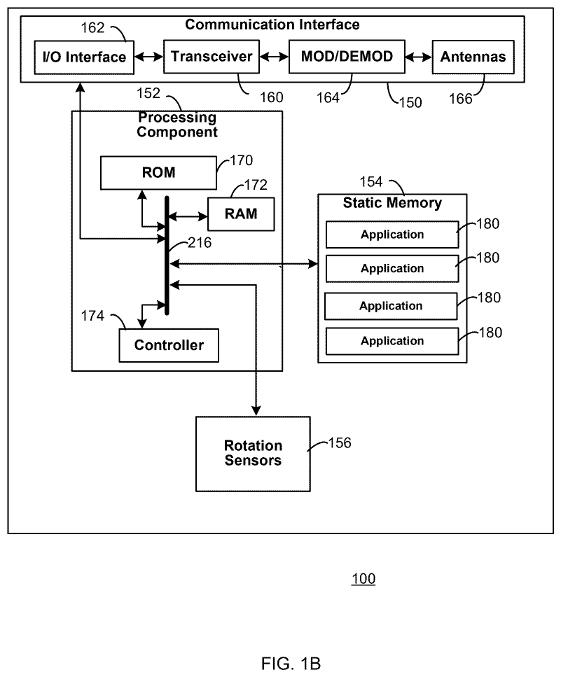

FIG. 1A illustrates a computing device 100 (also referred to herein as the device 100). The device 100 may be a mobile device such as handheld computer, vehicle mounted computer, or wearable computer. The device 100 may be a lightweight handheld computer such as a smartphone or a more rugged device for use in a warehouse, for example. The device 100 can, in other examples, include any of a wide variety of other computing devices, such as a barcode scanner, a tablet computer, or the like. The device 100 includes a housing 104 supporting various other components of the device 100, including a display 108, e.g., integrated with a touch screen. The housing 104 and the display 108 can cooperate to define an interior of the device 100, containing processing components.

FIG. 1B illustrates a schematic block diagram of an example of the device 100. The device 100 includes a communication interface 150, a processing component 152, memory 154, and one or more rotation sensors 156.

The communication interface 150 may include one or more transceivers 160, input/output (I/O) interfaces 162, modems 164, and antennas 166. The I/O interfaces 162 may include one or more wired and/or wireless interfaces that are configurable to communicate with suitable components of the device 100. For example, the I/O interfaces 162 may interface with the touch screen of the display 108.

The one or more transceivers 160 may be adapted for communication with a communication network using the antennas 166. For example, the one or more transceivers 160 may be adapted for communication with one or more wireless local area networks, such as a Bluetooth network or a Wi-Fi network. The one or more transceivers 160 may further be adapted for communication with one or more wireless wide area networks, such as a cellular network including Long-Term Evolution (LTE), 5G, 6G networks, and other known or proprietary communication networks. The transceivers 160 may be further adapted to for use in reading and/or writing data to or from wireless tags, such as RFID tags for example, and exchanging data via near-field communication (NFC), or the like. In some embodiments, the antennas 166 may be contained entirely within the housing 104. In some embodiments, an external antenna or antennas may be provided.

The communication interface 150 may further include one or more wired transceivers 160, such as an Ethernet transceiver, a USB (Universal Serial Bus) transceiver, or similar transceiver configurable to communicate via a physical connection to the communication network. The transceiver 160 may also be coupled to the modem 164.

The processing component 152 may include a Read Only Memory (ROM) 170, a Random Access Memory (RAM) 172, and a controller 174. The ROM 170, the RAM 172, and the controller 174 are communicatively coupled. Further, the communication interface 150 and the memory 154 are communicatively coupled to the processing component 152.

The memory 154 provides a non-transitory computer readable medium for storing machine readable instructions to implement one or more programs or applications 180, including program code and/or application data.

Thus, for example, the memory 154 stores program code as a set of instructions corresponding to the one or more applications 180 that, when executed by the controller 174, enables the controller 174 to implement functionality to determine the direction to an RFID tag.

The applications 180 may include programmatic algorithms, and the like, to implement functionality as described herein. Alternatively, or in addition to programmatic algorithms, the applications 180 may include one or more machine learning algorithms to implement functionality as described herein.

The one or more machine learning algorithms of the application and/or the algorithms may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

Furthermore, in examples where the applications 180 include one or more machine learning algorithms, the applications may be operated in a training mode to train the application to implement the functionality described herein.

In the prior art, multiple antennas are implemented to improve determining the location of the RFID tag. This strategy uses two or more antennas at a fixed distance to triangulate the RFID tag. However, this solution is impractical because the device used to locate the RFID tag is typically small, which would result in the antennas being too close together to provide any significant improvement. Setting up multiple antennas in the large facility would be costly. As described herein, these deficiencies are overcome by provide an application 180 configured to determine the location of the RFID tag.

The one or more rotation sensors 156 include motion and orientation sensors such as accelerometers, gyroscopes, magnetometers, and various combinations thereof. The rotation sensors 156 can be used to facilitate determination of the pitch and yaw of the device 100.

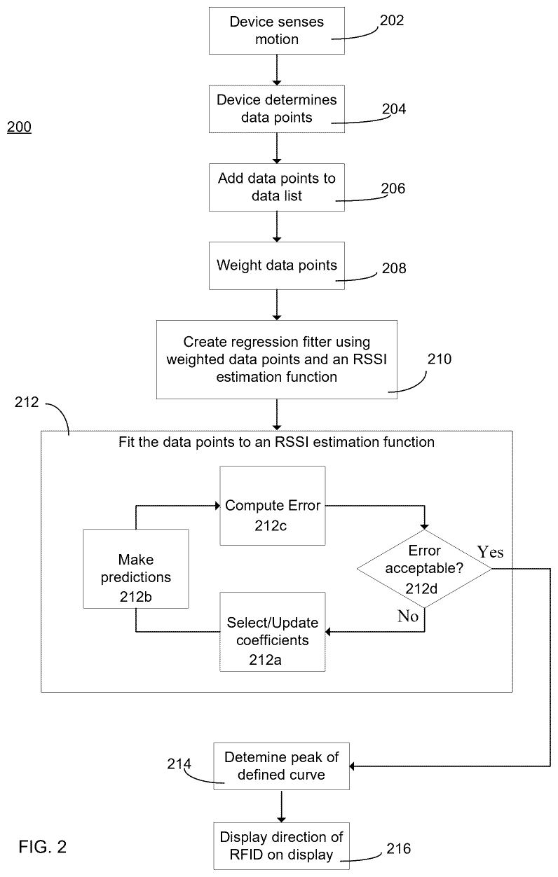

Referring to FIG. 2, a flow chart illustrating a method for identifying a direction of an RFID tag is illustrated generally by numeral 200. At block 202, the device 100 senses motion. In some embodiments, the user moves the device 100 in response to a prompt from the device 100. For example, if the user is attempting to locate an RFID tag, the user enters an identifier for the RFID tag into the device. In response, the device prompts the user to move the device 100. In some embodiments, the device 100 detects motion as the user uses the device 100 or walks around.

At block 204, the device 100 reads and stores information related to the RFID tag. Multiple readings for the RFID tag are obtained within a predefined time, referred to as a read window. The number of readings can be selected to reduce overhead for obtaining and storing data. For example, testing has shown that in some embodiments as few as ten readings are sufficient to identify the location of the RFID tag. If storage is less of a concern, then a greater number of readings can be obtained during the read window. For each reading, a Received Signal Strength Indicator (RSSI) associated with the RFID tag is determined. The RSSI is determined, at least in part, based on the signal strength of the RFID tag signal received at the RFID antenna 166. The angle data of the device 100 at the time of the reading is also recorded. The angle data is determined, at least in part, based on the readings from the rotation sensors 156. For each reading, the RSSI and the angle data are correlated to create a data point. In some embodiments, a timestamp of the reading of the RSSI and the angle data is also recorded and included in the data point. In some embodiments, the angle data is the angle of the device in the horizontal plane.

At block 206, the data points collected within the read window are added to a data list. The data list is stored in the memory 154. In some embodiment, the number of data points stored in the data list may be capped. For example, in some embodiments, the data list stores a maximum of 100 data points. Once the data list reaches capacity, the oldest data points are deleted to make room for incoming new data points. Accordingly, it will be appreciated that the data list acts as a first-in, first-out (“FIFO”) data structure. The maximum size of the data list is configurable.

At block 208, the data points in the data list are weighted. In some embodiments, the newer half of the data points are considered new data points, and the older half of the data points are considered old data points. The new data points are weighted by a weighting factor of one. The old data points are weighted by a weighting factor of less than one. In some embodiments, the old data points are weighted using weight degradation. That is, the older the data point, the lower the weighting factor. For example, the old data points are weighted from newest to oldest by weighting factors of 0.98619, 0.98619² . . . 0.98619⁵⁰, respectively. The weighting power of the weighting factors is configurable.

At block 210, a regression fitter is created using the weighted data points. The regression fitter is configured to determine the coefficients that best fit the RSSI estimation function:

$$y = {c}_{0} + {c}_{1} \times ln ( {c}_{2} + {c}_{3} sin ( x ) + {c}_{4} cos ( x ) ) \qquad Equation 1$$

where x is the angle of the data point and y is the RSSI value of the data point. Coefficients c₀ and c₁ are representative of the natural loss of RSSI as a function of distance. For example, the free-space loss is a measure of how much signal power is lost over a given distance. For example, in some embodiments, coefficient c₀ corresponds to the minimum RSSI observable by the device 100 and coefficient c₁ corresponds to a range of observable RSSI values. The coefficients c₂, c₃, and c₄ are representative of the peak angle where the RFID tag is expected to be located.

Equation 1 is an example of a non-linear equation. Specifically, Equation 1 is a Log-Trigonometric equation. The logarithmic nature of the equation accommodates the RSSI, which is measured on a logarithmic, or power-of-10, scale in decibel milliWatts (dBm). Further, the trigonometric nature of the equation accommodates the angle data, which represents the circular nature of the rotation of the device 100.

At block 212, the regression fitter fits the data points to Equation 1. Specifically, the value of the coefficients c₀, c₁, c₂, c₃, and ca are modeled to make the output y match the weighted data as closely as possible. In some embodiments, gradient descent training is used to achieve this result. For example, at block 212a the coefficients are selected. At block 212b, values of the output y are determined for the selected coefficients. At block 212c, the determined values are compared with the data points to compute an error. At block 212d, it is determined whether the error is within an acceptable range. Once the error is within the acceptable range, the regression has identified coefficients for Equation 1 that define a representative curve representing the weighted data points.

In some embodiments, the gradient descent training is implemented by minimizing the Mean Square Error (MSE) loss function. The loss function quantifies the difference between the predicted RSSI values using the model of Equation 1 and the actual RSSI values. The resulting difference, referred to as the loss, reflects the accuracy of the model's predictions. During the gradient training, a learning algorithm uses the gradient of the loss function to adjust the coefficients and reduce the loss, effectively improving the model's performance.

In some embodiments, if the error gradient is less than 1E-6 then the error is considered within the acceptable range. In some embodiments, if the current error gradient is 1E-4 less than the previous error gradient, then the error is considered within the acceptable range. In some embodiments, if the error gradient is less than 1E-6 or the current error gradient is 1E-4 less than the previous error gradient, then the error is considered within the acceptable range.

If the error is not within the acceptable range, then the model training continues at block 212a and the coefficients are updated. If the error is within the acceptable range, then the model training is complete.

At block 214, the peak of the defined curve is determined. At block 216 the estimated direction of the RFID tag is displayed on the display 108 of the device 100. As will be described below, the direction is determined based on the peak of the defined curve.

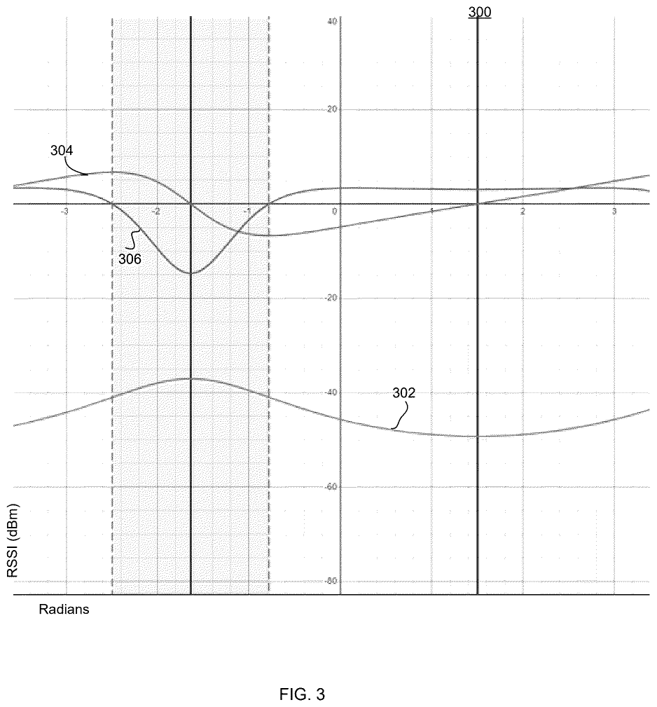

Referring to FIG. 3, a graph illustrating an example of a defined curve 302 is illustrated by numeral 300. As illustrated, the periodicity and geometric form of the defined curve 302 guarantee the existence of the global maximum on the interval [−π, π]. The first derivative 304 of the defined curve 302 identifies potential maximum and minimum values. The second derivative 306 of the defined curve 302 identifies which of the potential maximum and minimum values from the first derivative 304 is the maximum value. Specifically, a positive second derivative indicates a minimum and a negative second derivative indicates a maximum. The angle at which the maximum value occurs, that is where the RSSI is the highest, is the direction of the RFID tag.

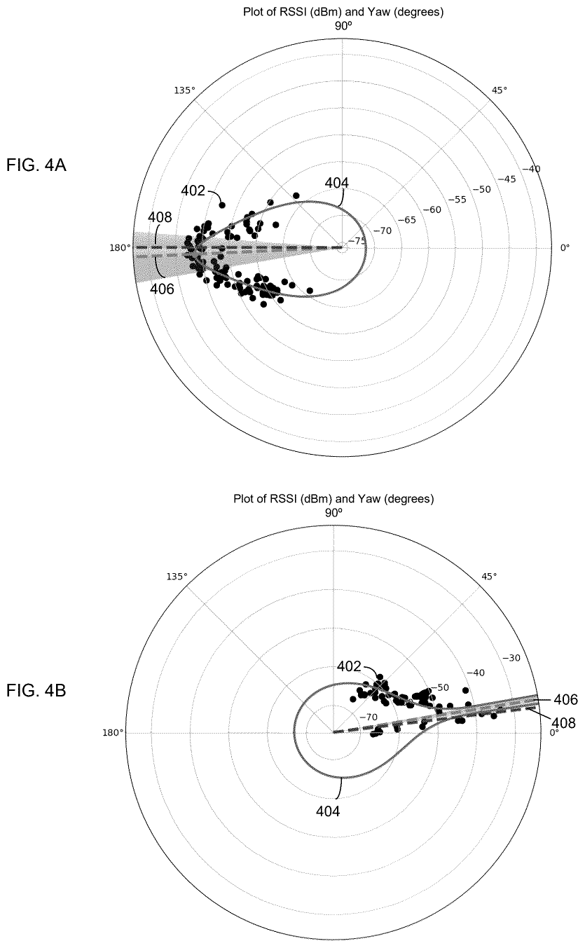

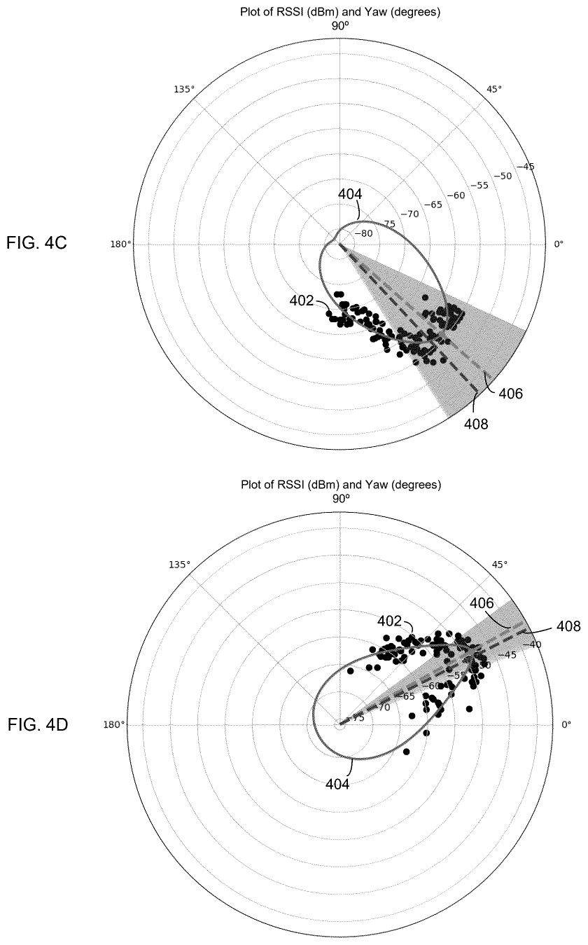

Referring to FIGS. 4A to 4D, example curves for different distributions of data points are illustrated. The dots 402 represent the data points, the solid line 404 represents the defined curve, the dashed line 406 represents the predicted angle of the RFID tag, and the dashed line 408 represents the true angle of the RFID tag. Initial testing suggests that the modeling takes up to 100,000 steps over 0.6-1.2 seconds on a mobile device 100. Performance analysis suggests an average error of less than 3.3°.

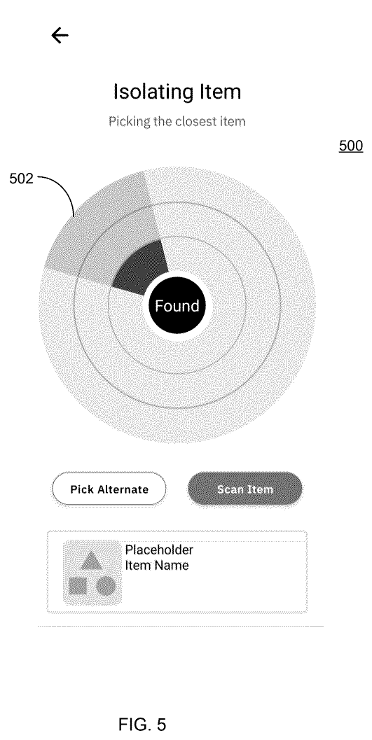

Referring to FIG. 5, an example of the display 108 of the device 100 showing the location of the RFID tag is illustrated by numeral 500. In the display 500, the RFID tag identifier for a target item, such a t-shirt for example, has been entered into the device 100. After a short wave, left and right, of the device 100, enough data was collected to locate the item, as described above with reference to FIG. 2. The direction of the target item is illustrated as a wedge shape 502 on the display 500. As the device 100 moves, the wedge shape 502 stays pointing towards the target item. Thus, the device 100 provides a visual indicator identifying a location of the target item to the user of the device 100. In some embodiments, the location of the device may be shown on a device 100 other than the device 100 that actually determines the location of the target item. For example, the location of the target item may be determined by a portable computing device with the hardware necessary to do so. The location of the target item may then be displayed on smartwatch communicatively coupled to the portable computing device.

The regression model described above provides a number of technical advantages. For example, the defined curve can be computed using as few as 10 data points per reading and storing up to five readings (50 data points). Thus, determining the location of the RFID tag can be implemented while maintaining a low memory overhead. The regression model is also resistant to noise and outliers since it fits the equation to the underlying relationship in the data. The regression model can also extrapolate the positions of peaks outside of the recorded data. The regression model also fully captures the complex shape of the data.

The data points can be updated and the regression model re-trained to help locate the RFID tag. In some embodiments, the device 100 updates the data points and re-trains the regression model in response to changes in the environment. For example, when the user is walking towards the RFID tag. In some embodiments, the device 100 updates the data points and re-trains the regression model in response to a request from a user. For example, if someone has moved the RFID tag and the user is having difficulty locating it.

In the embodiments described above, only the yaw of the device 100 was included in the data points and considered for the gradient descent training. That is, the angle of the device 100 in the horizontal plane. In some embodiments, the rotation sensors 156 include sensors such as gyroscopes that can capture the pitch of the device 100, as well as the yaw. That is, the angle of the device 100 in the vertical plane. As will be appreciated, in some embodiments, the horizontal and vertical planes are the absolute horizontal and vertical planes. In some embodiments, the horizontal plane is the plane parallel to the screen 108 of the device and the vertical plane is the plane perpendicular to the horizontal place. In this embodiment, the model training is designed to minimize the volume of the surface generated by the RSSI estimation function while limiting the square distance of points lying outside the boundary of the surface (the Mean Square Outlier Distance). A 3D surface function “bubble” is generated that encloses the data points for the RFID tag to estimate its direction.

In this embodiment, the RSSI estimation function is:

$$R ( {θ}_{i} ϕ ) = ( {c}_{1} + {c}_{2} ln ( 1 + {c}_{3} + cos ( θ - {c}_{4} ) ) ) cos ( ϕ - {c}_{5} ) \qquad Equation 2$$

where R(θ, φ) is the RSSI value of the data point, θ is the pitch angle with respect to the vertical plane, and φ is the yaw angle with respect to the horizontal plane. Coefficient c₁ is a minimum size of the RSSI bubble. Coefficient c₂ is the eccentricity/radial variance of the RSSI bubble. Coefficient c₃ is a rotational significance, which has an inverse relationship with the significance of the yaw of the device 100. Coefficient c₄ is a yaw direction of the RFID tag. Coefficient c₅ is a pitch direction of the RFID tag. The coefficients have constraints such that c_{3°}>0, −π<c₄≤π, and 0<c₅<π.

During training the RSSI estimation function is optimized as follows:

$$Obj = ( 1 + \frac{M}{5} ) \cdot \sqrt[3]{V}$$

$$V = \frac{1}{3} {\int }_{- π}^{π} {\int }_{- \frac{π}{2}}^{\frac{π}{2}} {R ( θ , ϕ )}^{3} \cdot sin ( ϕ ) d ϕ d θ$$

$$M = \frac{1}{N} {\sum }_{i = 0}^{N} [ {( r [ i ] - R ( θ [ i ] , ϕ [ i ] ) )}^{2} \cdot I ( r [ i ] > R ( θ [ i ] , ϕ [ i ] ) ) ]$$

and I is an indicator function that outputs 1 when the condition is met and 0 otherwise. To optimize the objective function, the gradient is determined as:

$$∇ Obj = \frac{1}{3} {V}^{- 2 / 3} ( 1 + \frac{M}{5} ) \cdot ∇ V + \frac{1}{5} \sqrt[3]{V} \cdot ∇ M$$

$$∇ V = {\int }_{- π}^{π} {\int }_{- \frac{π}{2}}^{\frac{π}{2}} ∇ R ( θ , ϕ ) \cdot {R ( θ , ϕ )}^{2} \cdot sin ( ϕ ) d ϕ d θ$$

$$∇ M = \frac{- 2}{N} {\sum }_{i = 0}^{N} [ ∇ R ( θ [ i ] , ϕ [ i ] ) \cdot ( r [ i ] - R ( θ [ i ] , ϕ [ i ] ) ) \cdot I ( r [ i ] > R ( θ [ i ] , ϕ [ i ] ) ) ]$$

where, for each cᵢ:

$$\frac{\partial R}{\partial {c}_{1}} = 1$$

$$\frac{\partial R}{\partial {c}_{2}} = ln ( 1 + {c}_{3} + cos ( θ - {c}_{4} ) ) \cdot cos ( ϕ - {c}_{5} )$$

$$\frac{\partial R}{\partial {c}_{3}} = \frac{{c}_{2}}{1 + {c}_{3} + cos ( θ - {c}_{4} )} \cdot cos ( ϕ - {c}_{5} )$$

$$\frac{\partial R}{\partial {c}_{4}} = \frac{{c}_{2} sin ( θ - {c}_{4} )}{1 + {c}_{3} + cos ( θ - {c}_{4} )} \cdot cos ( ϕ - {c}_{5} )$$

$$\frac{\partial R}{\partial {c}_{5}} = ( {c}_{1} + {c}_{2} ln ( 1 + {c}_{3} + cos ( θ - {c}_{4} ) ) ) \cdot sin ( ϕ - {c}_{5} )$$

All these equations are used to solve for the gradient of the tunable coefficients with respect to the objective function Obj. Each coefficient cᵢ is updated as

$${c}_{i} = {c}_{i} - α [ i ] \cdot \frac{\partial Obj}{\partial {c}_{1}}$$

using the values α=[0.1, 0.1, 0.001, 0.005, 0.0005].

Once the curve has been determined from the RSSI estimation function, the direction of the RFID tag is determined. To find the direction, the value of the angle pair (θ, φ) pair that maximizes R(θ, φ) is calculated. To determine the angles where R(θ, φ) has a maximum or minimum the angle pair (θ, φ) that satisfy R_{θ}=R_{φ}=0 is determined.

As will be appreciate, R_{θ}=R_{φ}=0 when 0=c4+πn and φ=c5+πn for some integer n. Further, the parameters are defined as φ=c₅ and θ=c₄, c₄±π depending on whether c₄ is positive or negative. Then, it is only necessary to evaluate R(θ, φ) for two combinations of values to determine which is greater. The greater value identifies the maximum since a surface can't have two consecutive minima when one of the two input variables is fixed. In other words, it is guaranteed that either (c₄, c₅) or (c₄±T, c₅) are the angles that maximize R(θ, φ) and therefore are the yaw and pitch direction of the RFID tag.

In some embodiments, some of the training calculations can be simplified by recognizing that coefficients c₄ and c₅ only rotate the surface and do not affect the volume. Thus, the gradient of these coefficients with respect to volume is 0. Rather, they are only affected by the square distance of outliers.

This quality is especially effective since none of the volume integrals have an analytic solution. In the trial implementations, Monte-Carlo estimation of the integral has been used, which works well since it introduces a stochastic element to the training. This increases the likelihood of the model finding the global optimal parameters.

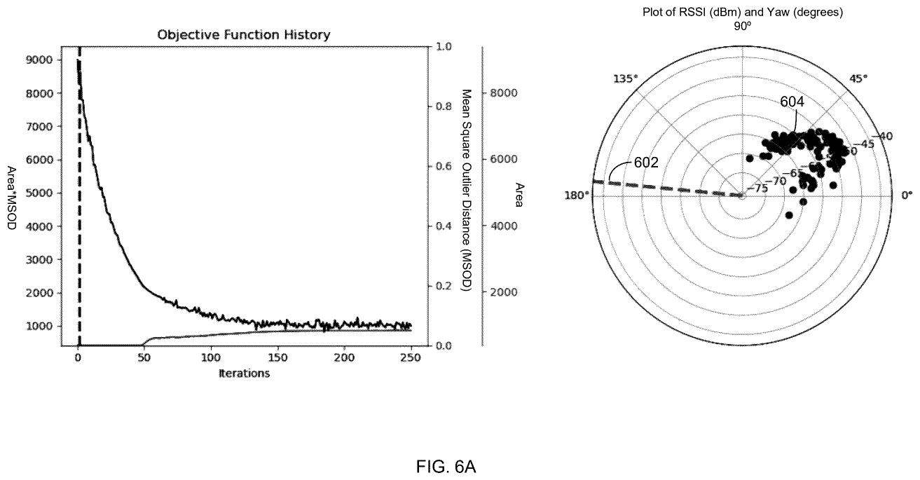

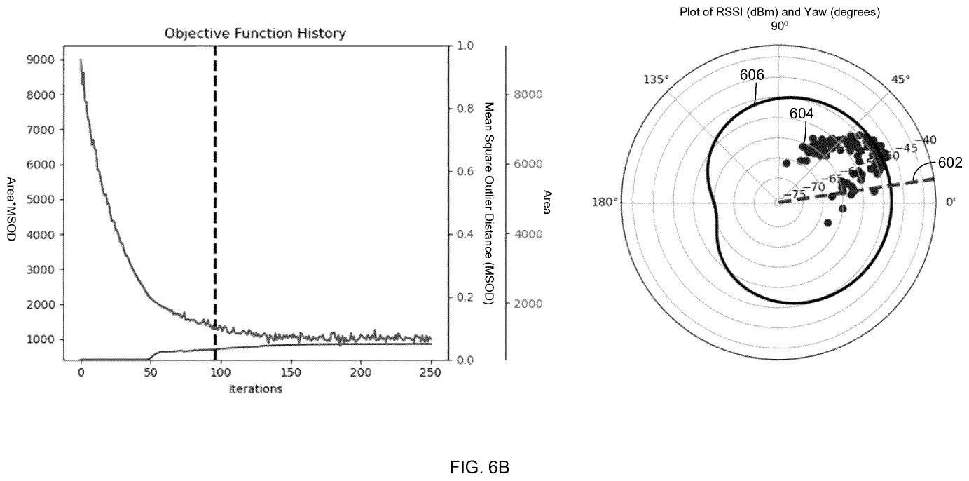

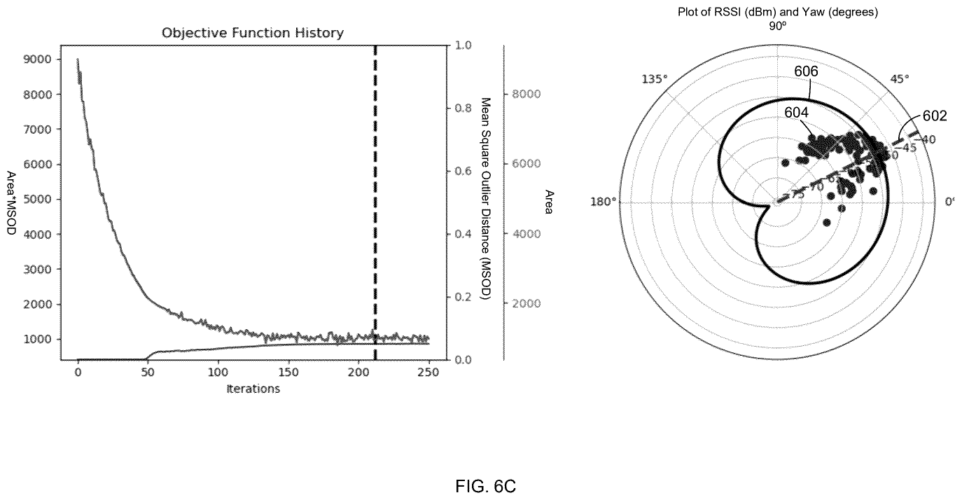

Referring to FIGS. 6A to 6C, an example of training the RSSI estimation function is illustrated graphically. As illustrated in FIG. 6A, initially, the volume of the surface generated by the RSSI estimation function is high and an estimated direction 602 of the RFID tag does not correspond with the plurality of data points 604. As illustrated in FIG. 6B, as the volume of the surface generated by the RSSI estimation function decreases, a curve 606 begins to take shape and the estimated direction becomes more accurate. As illustrated in FIG. 6C, the curve 606 represents the data points 604 and a maximum can be found to properly orient the estimated direction of the RFID tag.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of locating a wireless tag via a computing device, the method comprising:
using at least one rotation sensor to determine a plurality of angle data of the computing device in the horizontal plane during motion of the computing device;
processing a plurality of signal strength data of the wireless tag during the motion of the computing device;
creating a plurality of data points by correlating ones of the plurality of angle data with ones of the plurality of signal strength data;
training a non-linear regression machine learning model with the plurality of data points;
generating, at the computing device, a visual indicator of a direction of the wireless tag based on the training; and
displaying the visual indicator of the direction of the wireless tag at the computing device.

2. The method of claim 1, wherein training the non-linear regression machine learning model comprises training a non-linear signal strength estimation function to determine coefficients that best fit the non-linear signal strength estimation function to the plurality of data points to define a representative curve.

3. The method of claim 2, wherein the training comprises gradient descent training.

4. The method of claim 3, further comprising determining a maximum value in the defined curve, the maximum value representing a direction of the wireless tag, wherein generating the visual indicator is based on the maximum value in the defined curve.

5. The method of claim 4, wherein the gradient descent training comprises:
determining a compute error in the training of the non-linear signal strength estimation function;
determining whether the compute error is within a predetermined range; and
defining the representative curve as a curve that satisfies the non-linear signal strength estimation function when the compute error is within the predetermined range.

6. The method of claim 5, wherein the non-linear signal strength estimation function is y=c₀+c₁×ln(c₂+c₃ sin (x)+c₄ cos (x)), where y is the signal strength data and x is the angle data in the horizonal plane, wherein c₀ and c₁ are representative of the natural loss of RSSI as a function of distance, and c₂, c₃, and c₄ are representative of a peak angle where the wireless tag is expected to be located.

7. The method of claim 4, further comprising using the at least one rotation sensor to determine a plurality of angle data of the computing device in the vertical plane during motion of the computing device.

8. The method of claim 7, wherein the gradient descent training comprises minimizing the volume of the surface generated by the non-linear signal strength estimation function while limiting a square distance of points lying outside a boundary of the surface.

9. The method of claim 7, wherein the non-linear signal strength estimation function is R(θ, φ)=(c₁+c₂ ln(1+c₃+cos (θ−c₄))) cos (φ−c₅), where R(θ, φ) is the signal strength data, φ is the angle data in the horizonal plane, wherein c₁ is a minimum size of an RSSI bubble, c₂ is an eccentricity/radial variance of the RSSI bubble; c₃ is a rotational significance of the device, c₄ is a yaw direction of the wireless tag, and c₅ is a pitch direction of the wireless tag.

10. The method of claim 1, wherein the non-linear regression machine learning model is a Log-Trigonometric regression machine learning model.

11. A non-transitory computer readable medium having stored thereon instructions for locating a wireless tag, the instructions when executed by a processor of a computing device, cause the processor to:
use at least one rotation sensor to determine a plurality of angle data of the computing device in the horizontal plane during motion of the computing device;
process a plurality of signal strength data of the wireless tag received at one or more antennas during the motion of the computing device;
create a plurality of data points by correlating ones of the plurality of angle data with ones of the plurality of signal strength data;
train a non-linear regression machine learning model with the plurality of data points; and
generate, on a display of the computing device, a visual indicator of a direction of the wireless tag based on the training.

12. The non-transitory computer readable medium of claim 11, wherein training the non-linear regression machine learning model comprises training a non-linear signal strength estimation function to determine coefficients that best fit the non-linear signal strength estimation function to the plurality of angle data and the plurality of signal strength data to define a representative curve.

13. The non-transitory computer readable medium of claim 12, wherein the training comprises gradient descent training.

14. The non-transitory computer readable medium of claim 13, further comprising determining a maximum value in the defined curve, the maximum value representing a direction of the wireless tag, wherein generating the visual indicator is based on the maximum value in the defined curve.

15. The non-transitory computer readable medium of claim 14, wherein the gradient descent training comprises:
determining a compute error in the training of the non-linear signal strength estimation function;
determining whether the compute error is within an acceptable range; and
defining the representative curve as a curve that satisfies the non-linear signal strength estimation function when the compute error is within the acceptable range.

16. The non-transitory computer readable medium of claim 15, wherein the non-linear signal strength estimation function is y=c₀+c₁×ln(c₂+c₃ sin (x)+c₄ cos (x)), where y is the signal strength data and x is the angle data in the horizonal plane, wherein c₀ and c₁ are representative of the natural loss of RSSI as a function of distance, and c₂, c₃, and c₄ are representative of a peak angle where the wireless tag is expected to be located.

17. The non-transitory computer readable medium of claim 14, further comprising using the at least one rotation sensor to determine a plurality of angle data of the computing device in the vertical plane during motion of the computing device.

18. The non-transitory computer readable medium of claim 17, wherein the gradient descent training comprises minimizing the volume of the surface generated by the non-linear signal strength estimation function while limiting a square distance of points lying outside a boundary of the surface.

19. The non-transitory computer readable medium of claim 17, wherein the non-linear signal strength estimation function is R(θ, φ)=(c₁+c₂ ln(1+c₃+cos (θ−c₄))) cos (φ−c₅), where R(θ, φ) is the signal strength data, φ is the angle data in the horizonal plane, wherein c₁ is a minimum size of an RSSI bubble, c₂ is an eccentricity/radial variance of the RSSI bubble; c₃ is a rotational significance of the device, c₄ is a yaw direction of the wireless tag, and c₅ is a pitch direction of the wireless tag.

20. The non-transitory computer readable medium of claim 11, wherein the non-linear regression machine learning model is a Log-Trigonometric regression machine learning model.
